(19) United States
(12) Patent Application Publication
(10) Pub. No.: US 2017/0242466 A1
(43) Pub. Date: Aug. 24, 2017

(54) STANDBY POWER CONTROLLER FOR COMPUTER INSTALLATION

(71) Applicant: Embertec Pty Ltd, Dulwich, South Australia (AU)

(72) Inventors: Domenico Gelonese, Dulwich, South Australia (AU); John Haskey, Dulwich, South Australia (AU)

(21) Appl. No.: 15/505,943

(22) PCT Filed: Aug. 26, 2015
(86) PCT No.: PCT/AU2015/000510

§ 371 Date: Feb. 23, 2017

(30) Foreign Application Priority Data
Aug. 26, 2014 (AU) 2014903359
Jan. 30, 2015 (AU) 2015900275
Jan. 30, 2015 (AU) 2015900279

(51) Int. Cl. G06F 1/26; G06F 1/32

(52) U.S. Cl. CPC G06F 1/266; G06F 1/3287; G06Q 50/06

(57) ABSTRACT

A computer implemented system for improving energy efficiency in an electricity supply network. The system creates a data link to an external remote management centre and receives from the remote management centre a schedule which describes when the computer is required not to be in a low power standby state. The computer is required to be available for use during this period, even if no user is physically present. The system will then instruct the operating system of the computer to be in a use state other than a low power standby state during that time period, that is not in hibernation or sleep of off.

### FIELD OF THE INVENTION

The present invention relates to an apparatus and method to regulate the supply of power to and to control the power modes of a device, in particular a computer, in response to external information.

### BACKGROUND

In a deregulated electricity market energy retailers undertake to supply electricity to consumers. The energy retailers then source this electricity from energy generators who generate the electricity using a variety of power plants, each having its own running costs and lead time to come on stream.

The price which the energy retailer pays the electricity generators for this electricity is affected by many factors including supply contracts and government regulation, but in general is driven by supply and demand. That is, in times of high demand, the price paid by the electricity retailer increases. Demand varies continuously by time of day and time of year. The price variation may be many orders of magnitude, with, for example, the marginal price of an additional kWh (kilowatt hour) varying from one cent to more than ten thousand dollars.

Due to commercial realities and political constraints, and technical limitations, it is not possible for the energy retailer to simply pass on the marginal cost directly to the consumer. The cost to the consumer of a kWh is generally fixed at a price significantly greater than the lowest marginal cost payable by the energy retailer, but very much less than the maximum possible marginal cost payable by the energy retailer; generally from tens to hundreds of cents per kWh. The consumer tariff may include coarse variation by time of day and time of year, with higher prices for periods expected to be peak demand periods, but there is no direct relationship between the marginal cost paid by an energy retailer at a given time and the amount being paid by the consumer using that marginal kWh.

Energy retailers, producers and distributors, in regulated or deregulated markets, may be placed in a position where demand for energy exceeds the available supply. This can lead to brownouts where the electricity supply to some areas is cut in order to maintain supplies to at least some areas. Blackouts may also be experienced should demand cause the voltage in the distribution network to drop below critical levels.

Computer devices, in particular personal computer devices, are routinely designed to enter a low power or standby mode when a user has not operated the computer for a defined period of time. We refer to this mode as a low power standby mode.

The low power standby mode is a mode where the computer cuts or reduces the provision of power to superfluous areas of the computing device while the computer is not in use. Different degrees of reduction of power may be covered by the term low power standby mode which may be called “sleep” or “hibernate”. These allow a user to resume working or operating a machine from the standby mode without having to go through an extended reboot process. The difference between them is likely to be the speed with which the computer is able to return to full operating mode from the standby mode.

Entering a low power standby mode on a computer device will provide energy savings. However, users may find such entry to be inconvenient, especially when it is unexpected. Since the delay period for entering standby is typically set by the user a user will often seek to avoid unexpected entry into standby mode by setting extended time frames for the low power standby mode to be entered resulting in a significant delay before the onset of the energy saving functionality.

Typically, a computer device will determine when to enter a low power standby mode based on a time period for which user input, usually in the form of keyboard or mouse use, is absent. Since a computer may be in use without such user input, this may lead to unexpected and unwanted activation of the low power standby mode. Such an occurrence is likely to prompt a user to greatly extend the time period before the low power standby is entered, meaning that the computer spends significant amounts of time unused but in a high power use mode.

In a business environment, it is not uncommon for users to disable the automatic entry into standby power mode. It may be necessary for the computer to be available at times when no user is physically present in order for the computer to be remotely accessed for remote use, backup, or software update purposes.

### SUMMARY OF THE INVENTION

In a preferred form the invention may be said to lie in a computer implemented system for improving energy efficiency in an electricity supply network. The system creates a data link to an external remote management centre and receives from the remote management centre a schedule which describes when the computer is required not to be in a low power standby state. The computer is required to be available for use during this period, even if no user is physically present. The system will then instruct the operating system of the computer to be in a use state other than a low power standby state during that time period, that is not in hibernation or sleep of off.

In preference, the computer implemented system is further adapted to monitor an activity level of the computer in order to determine an activity mode of the computer. The system monitors activity such as mouse and keyboard use in order to determine if the computer is in active use, and upon determining that the activity mode has been other than active use mode for a time period exceeding a threshold time period; the system further acts to determine that the current time is not a time when the computer is required not to be in a low power standby state, that is to be available for use;

the system then acting to activate a user interface allowing a user to provide a user indication indicating that the computer should not be placed in a low energy use power state;

where such user indication is not provided, command the computer to enter a low energy power use state.

In preference, the remote management centre includes a demand response controller;

the computer implemented system further adapted to receive from said demand response controller a demand response event request;

upon receipt of said demand response event request command the computer to enter a low energy power use state.

In preference, the system further includes an energy saving device which has a monitored electrical outlet which supplies electrical power to the computer. There is a first sensor adapted to measure the electrical power supplied to the computer via the monitored electrical outlet and a communication module adapted to communicate said output to the computer implemented system.

In preference the energy saving device further includes at least one of a second type of electrical outlet which supplies electrical power to peripherals of the computer, and a second sensor which measures the electrical power supplied to the peripherals via the second electrical outlet. The communication module communicates the output of the second sensor to the computer implemented system.

In preference the computer implemented system communicates the output of the first and second sensor to the remote management centre.

In preference the communication module is a USB connection.

In an alternative, the communication module is a wireless connection.

The invention may further be said to lie in a computer implemented remote management centre for improving energy efficiency in an electricity supply network adapted to receive from a user a schedule of times when a computer is required to not be in a low power user state;

to receive a connection from each of a plurality of said computers and to communicate to each computer the schedule of times when that computer is required to not be in a low power standby state.

In preference, the computer implemented remote management centre is further adapted to receive from a plurality of computers data describing the power usage of the computer;

to receive from a plurality of installers data describing the place and electrical supply of the installation of said computers and to use this data to predict power usage of the computers in regard to parameters selected from time period, geographic area, utility supplying electricity and environmental descriptors.

In preference, the computer implemented remote management centre is further adapted to include a demand response controller, the controller able to receive from a Utility a demand response event request, and to select which of the plurality of computers should be requested to join the demand response event based on the parameters of the Utility request and previous information received from each computer, the remote management centre communicating the demand response event request to each of the selected computers when a connection from that computer is received.

In preference, the computer implemented remote management centre will predict energy savings which may be made by applying a demand response event request to the computers.

The invention may further be said to lie in an energy saving device including an electrical inlet adapted to connect to a general power outlet,

at least one monitored electrical outlet adapted to connect to a computing device,

at least one switched electrical outlet adapted to connect to, and to supply electrical power to, at least one peripheral device,

switch adapted to control electrical connection of the inlet to the switched electrical outlet, and thus to control supply of electric power to the at least one peripheral device,

sensor adapted to sense at least one characteristic of an electrical power flow through the monitored electrical outlet to the computing device, and to output results of said sensing as a first output;

a communication module adapted to communicate said first output to the computer device;

the energy saving adapted to receive an instruction from the computer that the switch should be operated and to operate the switch in response to said instruction.

The invention may further be said to lie in an energy saving device including an electrical inlet adapted to connect to a general power outlet,

at least one monitored electrical outlet adapted to connect to a computing device,

at least one switched electrical outlet adapted to connect to, and to supply electrical power to, at least one peripheral device,

switch adapted to control electrical connection of the inlet to the switched electrical outlet, and thus to control supply of electric power to the at least one peripheral device,

first sensor adapted to sense at least one characteristic of an electrical power flow through the monitored electrical outlet to the computing device and to output the result as a first output,

said first output being used to determine when the computing device is in a low power standby mode;

the energy saving device adapted to receive a schedule including at least one time at which the computing device is required to not be in a low power standby mode;

determining that the computing device is in a low power standby mode at a time when the schedule indicates that the computing device is required to not be in a low power standby mode;

upon said determination, providing a signal to the computing device which will cause the computing device to emerge from low power standby mode.

In preference, there is a second sensor which senses at least one characteristic of an electrical power flow through the switched electrical outlet to the computing device, the energy saving device communicating the outputs of the sensors to the computing device.

The invention may further be said to lie in a method for improving energy efficiency in an electricity supply network, including creating a data link from a computer to an external remote management centre, and receiving from the remote management centre a schedule which includes at least one time period when the computer is required not to be in a low power standby state, then instructing the operating system of the computer to be in a use state other than a low power standby state during that at least one time period.

In preference, the method has the steps of monitoring an activity level of the computer in order to determine an activity mode of the computer,

upon determining that the activity mode has been other than active use mode for a time period exceeding a threshold time period;

and determining that the current time is not within a time period which the schedule defines as a period when the computer is required not to be in a low power standby state;

activating a user interface allowing a user to provide a user indication indicating that the computer should not be placed in a low energy use power state;

where such user indication is not provided, commanding the computer to enter a low energy power use state.

### BRIEF DESCRIPTION OF THE DRAWINGS

FIG. 1 is an illustration of the elements of the system of the invention;

FIG. 2 is a representation of a single computer installation in a business environment including the system of the invention;

FIG. 3 is a block diagram of the energy saving device of FIG. 2;

FIG. 4 is a flow chart of the Hibernation Process;

FIG. 5 is a flow chart describing the PC Activity Monitor Process;

FIG. 6 is a flow chart describing the ESD Communication Process;

FIG. 7 is a flow chart describing the Cloud Communication Process;

FIG. 8 is a flow chart describing an abbreviated SCM process;

FIG. 9 is a flow chart describing an embodiment where the Schedule Data is stored in the ESD;

FIG. 10 is an example of a splash screen warning.

### DETAILED DESCRIPTION OF THE INVENTION

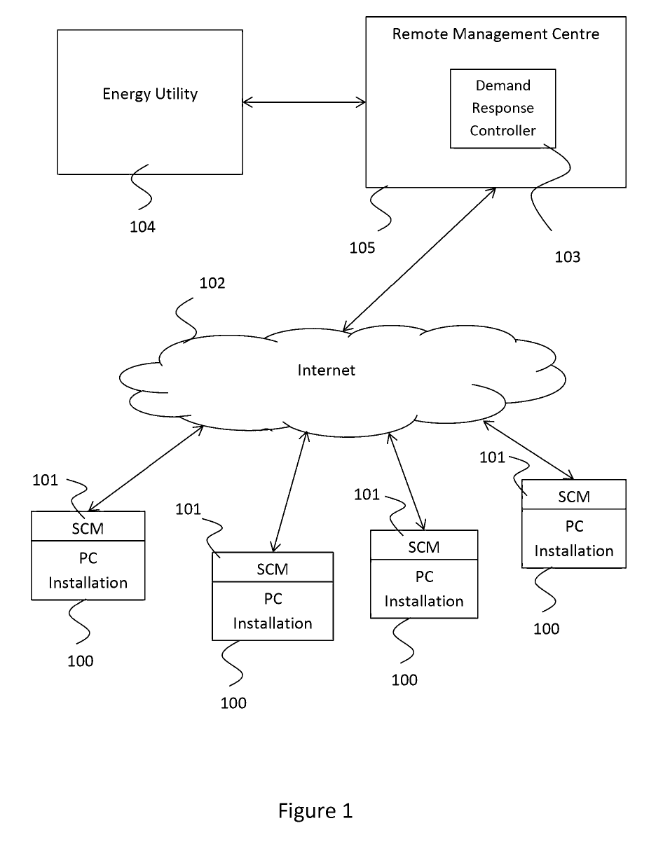

Referring now to FIG. 1, there are a number of PC installations 100. These personal computers are installed in a single enterprise. The PCs are connected to a network, in a preferred embodiment, an intranet.

In preferred embodiments, these PCs are supplied with electricity by an electricity supply network. At least some aspect of the electricity supply network is contributed by an Electricity Supply Utility 104. The Utility may be any or all of an electricity retailer, an electricity generator, an electricity distributor and an electricity network regulator. There may be more than one Utility.

The Utility provides or controls the provision of electricity to or by the electricity supply network. In a preferred embodiment, the Utility is an energy retailer. In high demand situations, energy retailers are forced to pay very high prices for electricity but are unable to pass these costs on to their customers. In such a situation, the Utility wishes to reduce electricity consumption by customers connected to the electricity supply network. Other possible scenarios, including restricted electricity supply, or restricted electricity distribution capacity may cause a Utility to wish to reduce electricity consumption by customers connected to the electricity supply network.

Each computer includes a Software Control Module (SCM) 101. Each SCM establishes communication with a Remote Management Centre (RMC) 105 via a communications network 102. The RMC is a processing system remotely located from the personal computer installation. In preferred embodiments, the RMC is in communication with the Utility 104.

The RMC is able to receive information concerning the power usage of a PC installation from the respective SCM. The RCM may aggregate and analyse this data and supply the results to the Utility.

As further described herein, the RMC is able to provide data to an SCM directing the manner in which the SCM acts to control aspects of the power usage of the PC installation.

In general, the RMC will be in communication with a number of such groups of PCs, installed in many different, unrelated enterprises.

The RMC includes a Demand Response Controller (DRC) 103. The DRC may receive from the Utility a demand response event notification, being an indication that a reduction in load on the electricity supply network is desirable. The DRC is then able to issue a demand response event request to the personal computer installations 100, via the RMC.

The demand response event request is intended to elicit a response from at least some of the personal computer installations whereby the installations move to a lower energy use state, thus relieving the load on the electricity supply network.

In the preferred embodiments, the communications network is the public internet. The nature of the public internet is such that in general, a personal computer will not have unrestricted, two way access to remote devices via the internet. Some form of firewall and/or network address translation (NAT) is likely to be in place. This will generally allow relatively unrestricted outgoing access, but will obstruct access to the PC from sources, such as the public internet, outside the local network to which the PC is connected. Accordingly, each SCM will establish the link to the RMC, allowing two way communications.

The RMC may be in communication many thousands of PCs. Maintaining communications links requires resources at both the personal computer and the RMC. In order to reduce resource use, in a preferred embodiment the link established between the RMC and each computer is held only briefly, for the time necessary for the computer to identify itself, and to transfer data concerning energy usage by the computer installation, and for the RMC to allow the DRC to indicate that a demand response event is in progress if that is the case. The link is then dropped and re-established by the personal computer at regular intervals. In a preferred embodiment, the interval is between five and fifteen minutes.

In other embodiments, the RMC may establish the communication link with some or all of the SCMs, where network access to the PC is able to be provided to the RMC. In further embodiments, the link between the RMC and the personal computer installations may be permanently maintained.

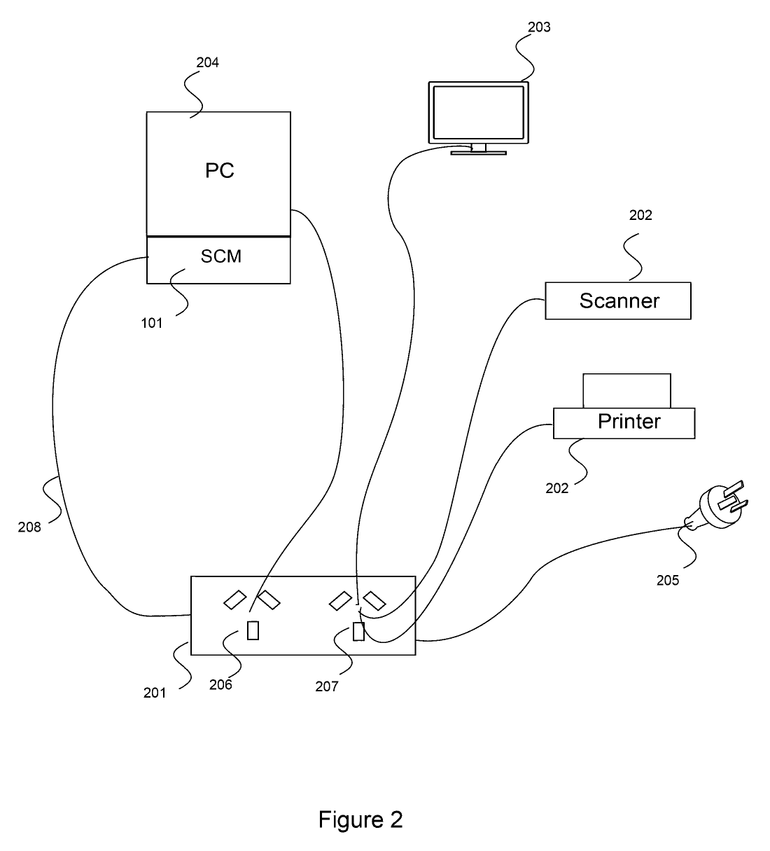

Referring now to FIG. 2, there is shown a diagram representing a typical PC of FIG. 1.

The PC installation includes a computer 204, which has a monitor 203. Also connected to the computer there may be peripheral devices 202 such as a printer or a scanner.

The computer runs the SCM 101 as previously described.

Electricity may be supplied to the computer 204, the monitor 203 and the peripheral device 202 via an energy saving device 201. In less preferred embodiments, the energy saving device may be absent, and the computer and peripherals may be provided with electricity directly from the GPO 205.

There is a GPO 205 which supplies electrical power to the energy saving device 201. The energy saving device includes monitored electrical outlet 206 which supplies electrical power to personal computer (PC) 204. Any suitable computing device may be used, and is encompassed by the term PC as used herein, including without limitation, Apple Macintosh computers; computers running Unix based operating systems; and laptop, notebook and tablet computers.

In less preferred embodiments, the energy saving device may be absent, and the computer and peripherals may be provided with electricity directly from the GPO 205.

There is a switched electrical outlet 207 which provides electrical power to devices used in the computing environment which require power only when the PC itself is in use. This includes, without limitation, the computer monitor 203 and computer peripheral equipment 202. It may also include equipment which is not part of the computer installation, but is nonetheless only required when the computer itself is in use, such as a desk lamp. The term “computer peripherals”, as used herein is to be taken to include, without limitation, at least all of the foregoing.

In an embodiment, the energy saving device also includes a communications channel 208 for communication to the PC, in a preferred embodiment, a USB channel. Other types of communication channel may be used, including, without limitation wireless communication ports and protocols. In other embodiments, communication between the energy saving device and the PC may not be direct, but may occur via a third device such as a communications server, or a public or private communications network, or any other suitable device or network. In further embodiments, the communication channel may be absent.

In an embodiment, not illustrated, the energy saving device 201 may also include one or more Always On outlets which provide power at any time the energy saving device is connected to the mains supply. The Always On outlets are used to supply power to devices which require power at all times, regardless of the power state of the PC or the peripherals. An example of such a device in a home computing environment would be a wireless router, which may be providing wireless network services to other devices in a home which are not art of the PC installation.

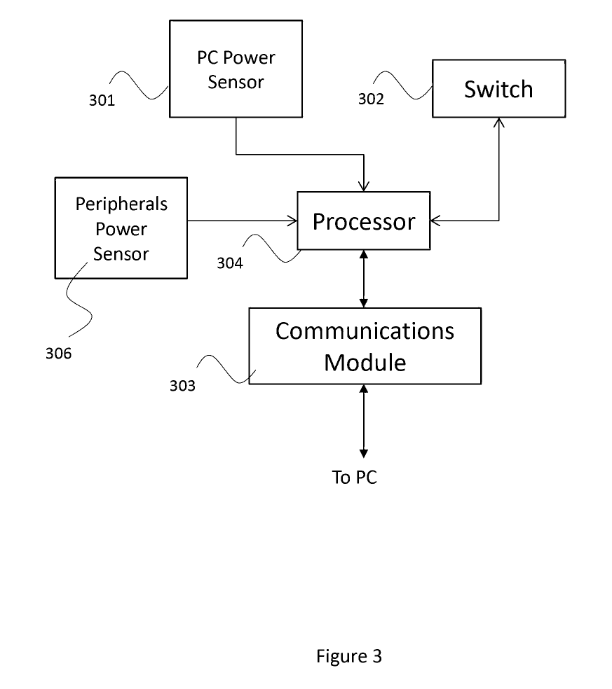

Referring to FIG. 3, which is a partial block diagram of the circuit of the energy saving device, there is provided a PC Power Sensor 301 which monitors the power drawn through the electrical outlet 206 which provides power to the PC. The PC Power Sensor may measure one or all of true RMS power, current, voltage and phase angle or power factor drawn by or across the PC which is connected to the outlet 206.

In a preferred embodiment, there is provided a second power sensor, being Peripherals Power Sensor 306, which monitors the power drawn through electrical outlet 207. The Peripheral Power Sensor may measure one or all of true RMS power, current, voltage and phase angle or power factor drawn by or across the load which is connected to the outlet 207. In general, this load will be the peripheral devices which may be switched off when the PC is not in active use.

There is also provided a switch 302, which operates to control the connection of electrical power from the GPO to the switched outlet or outlets 207.

There is a communication module 303 which provides data communication between the energy saving device and the SCM running on the PC. In the illustrated embodiment, this is a USB communications module, but any other suitable communication connection and protocol may be employed.

There is a processor 304. The processor receives the output of the sensors 301, 306 and controls the switch 302. The processor also receives data from, and sends data to, the SCM via the communications module.

In alternative embodiments, the communications module may be incorporated into the processor. Alternatively, the processor may be absent and the communications module may provide for direct communication with the PC by the sensor and the switch. In these embodiments, all functions of the processor described herein are undertaken by software running on the PC or another remote processor.

In other embodiments, the sensors, processor and communications module functions may be provided by a single unit.

The power usage detected by the PC Power Sensor 301, and by the Peripherals Power Sensor 306, if provided, is communicated to the SCM by the communications module 303. This may be communicated continuously or periodically. The processor may communicate instantaneous values of the power readings, or may accumulate total or average power values over time, and communicate these values in addition to, or instead of the instantaneous values.

In use, in preferred embodiments, the PC Power Sensor output is monitored by the processor to determine a functional state of the PC. The functional state may be determined from the characteristics and/or magnitude of the power drawn by the PC, as detected by the sensor. In a preferred embodiment, small fluctuations over short time periods in the power supplied to the PC through the energy saving device are monitored. Any or all of relative magnitude, absolute magnitude and frequency of the fluctuations may be monitored.

A greater level of power fluctuations indicates that the PC is in active use. Lower levels of power fluctuations, or the absence of power fluctuations, indicate that the PC is not in active use, although it may still be operating at full power. The fluctuations occur as a result of rapidly varying processor load and power drawn by such things as storage drives and graphics display units, which occur when the PC is responding to input from a user.

In other embodiments, the functional state of the PC may be determined by comparing the power drawn by the PC through the energy saving device to one or more pre-determined thresholds. These thresholds may include a time component, that is meeting the threshold may require the power to be within a particular value range for a particular time. When to power drawn is below a certain threshold, the functional state of the PC is determined to be the corresponding state.

In an embodiment, the processor distinguishes at least three functional states of the PC. These are Active Use, Full Power Standby, and Low Power Standby. Active Use is detected when the PC is in use, fully powered, and with a user interacting with or otherwise actively using the PC. Preferably, use which may not involve direct physical interaction with the PC, such as watching video material, or performing extended calculations, will be categorised as Active Use. Full Power Standby occurs when the PC is fully powered, but is not being actively used by a user, that is, there is no user interacting with the PC. Low Power Standby occurs when the PC has entered a low power state, which may be “sleep” or “hibernate”. These low power states may be separately identified by the processor. This state detection may also include the condition when the PC is off, which will be treated by the processor in the same manner as Low Power Standby.

In embodiments, the processor may not distinguish between Active Use and Full Power Standby, treating both as Active Use.

The determination of the functional state may include a duration component, that is, a change in state may be identified when a particular energy use situation has persisted for a given time period. The determination of a change in the determined functional state thus may not coincide in time with any specific change in the power usage of the PC.

In an embodiment, the PC will be determined to be in Active Use functional state when a sufficiently high level of power fluctuations is detected, over a sufficiently short period of time. Relative and absolute power measurements may also be used. Full Power Standby will be determined to be the functional state of the PC when there is a lower level of power fluctuation detected by the sensor for a sufficiently long period of time. A particular range of values of absolute or relative average power use by the PC may also be required in order for the functional state of the PC to be categorised as Full Power Standby by the energy saving device. The categorisation of the functional state of the computing device as Full Power Standby indicates that the PC is not being actively used by a user, but has not entered a low power standby mode.

In embodiments where the processor does not distinguish between Active Use and Full Power Standby, with both being determined to be Active Use, the determination of the Active Use state will be by absolute or relative power use thresholds, rather than analysis of short term fluctuations of the power usage.

The processor will cause the switch to operate to remove power from the switched electrical outlet 207 when Low Power Standby functional state is detected, thus removing power from the computer peripherals. This ensures that the computer peripherals are not drawing power unnecessarily during at least some of the time when the PC is not in use.

The PC runs the SCM which communicates with the energy saving device, the operating system of the PC, and the RMC. This software may run as a stand-alone program, as a service, as part of the computer operating system, or in any other convenient manner. It is a function of the SCM to cause the PC to move from Full

Power Standby to Low Power Standby. This saves energy in itself. Further, the move to Low Power Standby provides the opportunity for the energy saving device to remove the electricity supply to at least some components of the PC installation, which saves yet more energy.

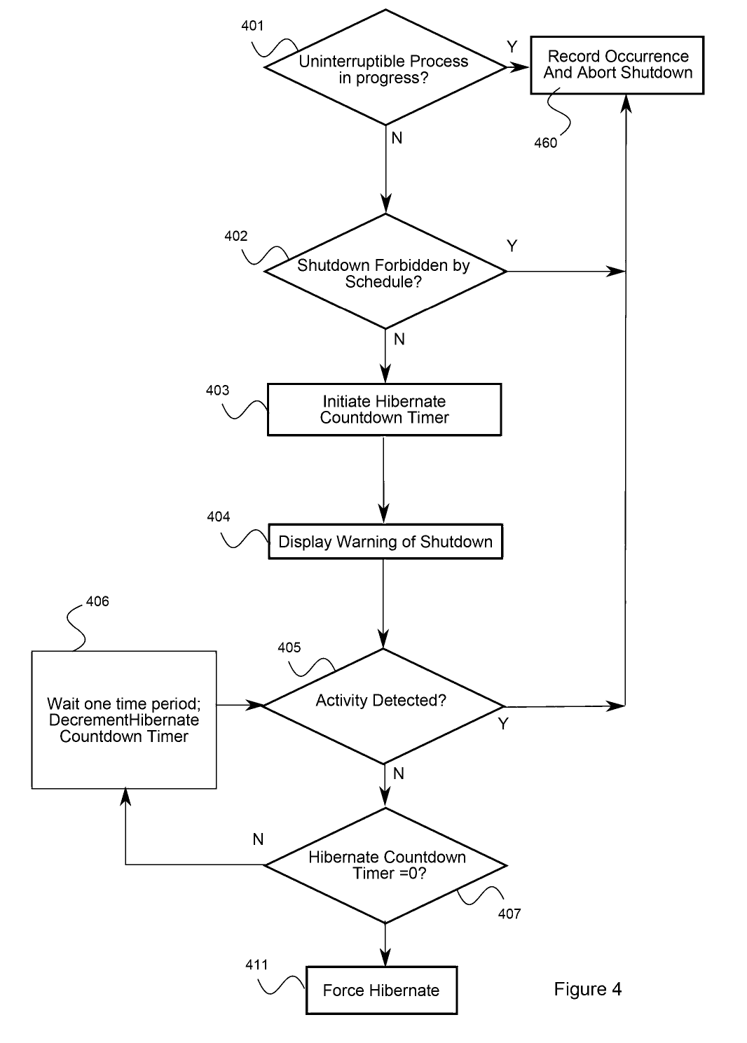

The process which the SCM runs to cause the PC to move into a Low Power Standby is the Hibernation Process illustrated in FIG. 4. This process is called when the SCM, with or without input from an energy saving device, has determined that the PC is in Active Standby mode.

The Hibernation Process begins with a check 401 to determine if any uninterruptible process is running. This check is made by checking the status of operating system flags which allow a process to indicate that the process is running and should not be interrupted. Where check 401 indicates that an uninterruptible process is in progress, the occurrence is logged and the shutdown process is aborted 460. In an embodiment, the SCM may be configured to ignore this check, and to attempt to move the PC to Low Power Standby despite the operating system indicating that a process is uninterruptible.

Where no uninterruptible process is detected, the Hibernation Process continues to make any other relevant checks to ensure that the PC should be shut down if the period of Active Standby continues. In the illustrated embodiment there is a check of a schedule 402. The SCM may include a user interface which allows a user to set scheduled periods during which no shutdown will take place, for example, Monday to Friday from 9:00 AM to 6:00 PM when it is known that the PC may be required for use on short notice and it is desired to avoid the PC being shut down. The schedule is also, or alternatively, able to be set by the RCM, and will also include maintenance windows set by the RCM, as further described herein.

Where check 402 indicates that the time of day is such that shutdown should not take place, the occurrence is logged and the Shutdown Process is aborted 440.

Where no impediment to moving the PC into a Low Power Standby mode is discovered, the process Initiate Hibernate Countdown Timer 403 is entered. A Hibernate Countdown Timer is set to a starting value. This starting value may be set by default or may be able to be pre-set by a user or by an external process. In a preferred embodiment, the value is set to ten minutes. This is the length of time during which the user is able to indicate that they are interacting with the PC and that they do not wish the PC to be placed into Low Power Standby mode. If no user is present, no such indication will be made, and the PC will be put into a Low Power Standby mode.

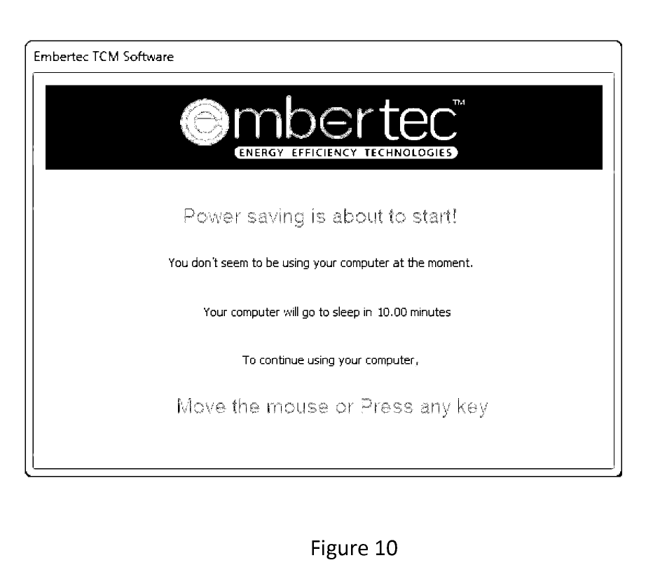

A warning of impending shut down is then displayed 404 as a splash screen on a PC monitor. An example warning is shown in FIG. 10. The text of the warning indicates that the PC will shortly be placed into a nominated Low Power Standby mode, which may be “sleep” or “hibernate” or any other suitable low power use mode of operation. The text invites a user to interact with the PC, by keystroke or mouse movement, in order to prevent the change in mode. The time left before shut down, being the value of the Hibernate Countdown Timer, may also be displayed.

The process then continues with a check 405 for any user interaction in response to the warning. If user interaction is detected, the Hibernate Process is then cancelled 6440. No shut down takes place.

A check 407 is then made to see if the Hibernation Countdown Timer has reached zero.

If no user interaction is detected, the Hibernate Countdown Timer is decremented 406 according to the elapsed time. A further check 405 is then made. This continues until either user interaction is detected by check 405, or the value of the Hibernate Countdown Timer is found to be zero at check 407. When the Hibernate Countdown Timer reaches zero, the action Force Hibernate 411 is undertaken. In this action, the operating system of the PC is instructed to place the PC into a Low Power Standby mode which may be “sleep” or “hibernate” or a hybrid low power mode determined by the SCM.

It is a function of the energy saving device that the processor will cause the switch to operate to remove power from the switched electrical outlet 207 when Low Power Standby functional state is detected, thus removing power from the computer peripherals.

When the PC is forced into Low Power Standby by the Hibernation Process, the power draw characteristics sensed by the sensor are analysed by the processor to identify that the PC is in Low Power Standby mode. The processor then controls the switch to remove power from the switched electrical outlet, thus removing power from the computer peripherals which are not needed when the PC is not in use.

Movement of the mouse, activation of the keyboard, or pressing the power on button on the PC will bring the PC out of Low Power Standby mode in the usual manner. The energy saving device will detect this change in functional state. The processor will then operate the switch to return power to the switched electrical outlet returning power to the computer peripherals.

The terms keystroke and mouse movement as used herein include analogous actions performed using other hardware, including without limitation, virtual keyboards, touchscreens, touchpads, trackballs and thumbwheels.

In a preferred embodiment, the SCM is coded to select “sleep” as the Low Power Standby mode. In other embodiments, the RCM or the SCM may include a user interface which allows a user to pre-set which mode should be chosen, or to set the specific parameters of a custom low power state.

In other embodiments, the display of the user warning may include an option to cause hibernation immediately, without waiting for the Hibernate Countdown Timer to count down. There may also be an explicit option which must be selected to prevent shut down, beyond merely moving a mouse or providing a key stroke.

In other embodiments, other measures indicating that the PC is in use, even if there is no user interaction, may be used in setting the value of User Inactivity. This may include, without limitation, the PC processor load, the throughput of any I/O (input/output) ports and whether the display of the computing device is active.

In embodiments where the processor is adapted to identify Full Power Standby, when the processor determines the functional state of the PC to be Full Power Standby, the processor communicates this to the SCM via the Communication Module. In the simplest embodiment, this communication will be the single command “Hibernate”, instructing the SCM to cause the PC to enter a low power standby mode, such as sleep or hibernate, if possible.

The identification of Full Power Standby is made by inference from the pattern of energy usage by the PC. It is possible that Full Power Standby may be misidentified. A determination of Full Power Standby may be made when in fact the mode is Active Use, that is, a user is engaged with the PC. The user may be only partly engaged, but may not wish the PC to move to Low Power Standby or to have power removed from the monitor and other peripherals. It is important that a user not be unduly inconvenienced. Accordingly, the SCM takes time—in a preferred embodiment on the order of 10-15 minutes—to move to Low Power Standby. In this time, warnings are provided which will be sensible to a present, fully or partly involved user, indicating that the move to Low Power Standby is imminent. Any interaction by the user with the PC will be sufficient to prevent the move to Low Power Standby. In the case where a demand response event notification has been received, avoiding user inconvenience is a lesser priority, so warnings may be curtailed.

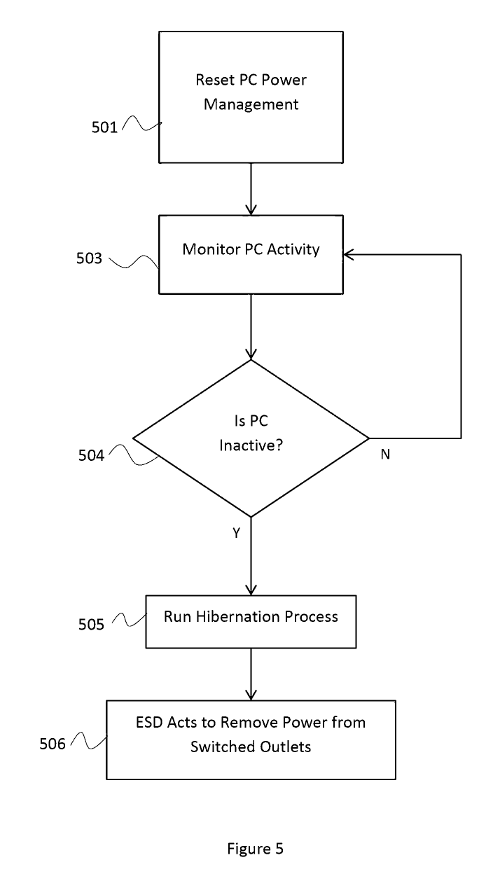

Referring to FIG. 5, there is shown a flowchart of the operation of the PC Activity Monitor process by which an embodiment of the SCM software communicates with the operating system of the PC.

The SCM software runs on the PC. Upon initiation, the SCM runs the process Reset PC Power Management 501. PC operating systems include power management features which cause the PC to enter various lower power states depending upon the activity level of the PC. In order for the SCM process to control the power management of the PC, the process Reset PC Power Management 501 disables power management features, or sets the activation parameters of such features to values which ensure the features will never activate while the SCM controls the power management of the PC.

The SCM then runs the process Monitor PC Activity 503. The process Monitor PC Activity 503 directly monitors use of mouse, keyboard and other inputs, the level of use of PC resources such as processor capacity, and any flags which may be set by the operating system to indicate that the PC is in use.

The results of this monitoring activity are used to determine 504 whether the PC is inactive. If the PC is not inactive, the monitoring continues 503.

Where the PC is determined to be inactive, the Hibernation Process of FIG. 4 is initiated 505.

When the Hibernation Process runs and moves the PC into a low power standby state, the Energy Saving Device acts 506 to remove power from the switched outlets.

An advantage of having control of the power management taken by the SCM is that the low power standby mode can be the lowest possible power usage mode. Low power usage modes consist of disabling or reducing power to various hardware and software components of the PC. The modes, such as “sleep” and “hibernate” provided by the operating system may not be the optimum for reducing power consumption. Direct control of the individual components of the power saving mode allows the SCM to achieve to optimal power reduction.

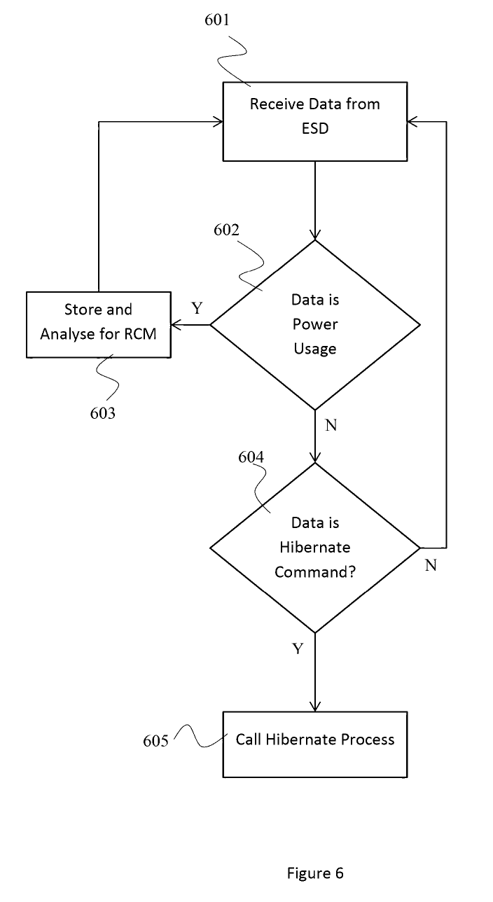

The SCM is in communication with the energy saving device 201 via a communication link which in a preferred embodiment is a USB link, but which may be any suitable communication link. This ESD Communication Process is shown in FIG. 6.

The SCM receives and analyses 601 data from the energy saving device 201.

The data may be power usage data from the energy saving device. The ESD sends data from each of the one or more power sensors.

If the SCM determines 602 that the data is usage data, the data is stored 603 for communication to the RCM. The data may also be analysed in order to report the analysis to the RCM. Values calculated may include, without limitation, aggregate energy use since the PC was last shutdown, energy used while the PC was in a low power standby mode, and aggregate energy used since the ESD was last power on. The usage data will include the power usage of the PC. This may be instantaneous power, or the ESD may calculate an aggregate usage over a time period, where the ESD has a memory facility. The data may include an energy signature for the PC. Where the data is communicated to the PC sufficiently rapidly, a series of instantaneous power readings from the ESD will allow the SCM to determine the power signature directly. Having stored and/or analysed the data the SCM continues to receive 601 data from the ESD.

If the data received from the ESD is not usage data, the data is checked 604 to determine if it contains a “Hibernate” instruction from the ESD, instructing that the PC should be placed in a Low Power Standby state. Where the data is determined not to be a hibernate instruction, the SCM continues to receive 601 data from the ESD.

The description of FIG. 3 discloses the circumstances in which the ESD will issue a Hibernate instruction.

Where a Hibernate command has been determined to have been received, the SCM calls 605 the Hibernate Process. In an embodiment, the SCM may check the output of Monitor PC Activity 503 before calling Hibernate Process, and refrain from calling the Hibernate Process if the output of Monitor PC Activity 503 indicates that the PC is not inactive.

In an embodiment, the SCM receives from the energy saving device the data describing the power usage of the computer. The processor of the energy saving device does not analyse the data to determine the power state of the computer. The SCM analyses the data describing the power use of the computer in the same manner as that described as being undertaken by the processor of the energy saving device. The SCM determines the power state of the computer from this analysis. If the state is determined to be Full Power Standby, the SCM proceeds in the same manner as described as if it had received a Hibernate instruction from the energy saving device.

In a business environment, it may not be acceptable for a PC to hibernate only based on the level of activity occurring locally on the individual PC. Corporate PCs have two “users” at any time. The first user is the apparent user, who is actually present at the PC and using the user interface such as mouse, keyboard and monitor. Detection of mouse, keyboard or other user input, and warnings via the monitor are sufficient to ensure that the PC is not caused to hibernate when the PC is in use by this user.

There may be another “user”. This is the corporate IT department, or other computer maintenance group. The IT department accesses the PC remotely, via a network, preferably a corporate intranet, but possible the public internet or other network. The IT department user is not in a position to type on a keyboard or move a mouse connected to the PC in order to wake a PC from a low power use mode. However, the IT department does need to have the PC available for a variety of maintenance tasks. This includes updating software, running virus scans and backing up hard disks. A commonplace requirement placed on PCs in a corporate environment is that the PC not enter a sleep or hibernate mode during specific hours to ensure the PC is available if required for the purposes of the IT department.

The times reserved for IT department access, often called maintenance windows, are often well outside business hours in order to minimize disruption to users caused by performing the IT department tasks. This means that PCs are often left for considerable periods of time, not in use, but unable to hibernate since if they were to hibernate, there would be no way to bring the PC out of hibernation to ensure that it is available during the maintenance window later that night.

The RMC provides a user interface which allows a user in the corporate IT department to set maintenance windows for PCs on the network. This interface is preferably provided as web interface, with a user login required. However, any suitable means of providing the interface, with appropriate security, may be employed.

The RMC interface may also permit corporate IT personnel to see the data reported to the RCM by each PC in the corporate network running the SCM software. This may include energy used by the PC, and by the peripherals of the PC. This may be reported as a time series, allowing changes in energy use over time, which may indicate faults to be picked up.

Data use may be reported by time of day, day of week, time of year, etc. Energy usage may be reported sorted by corporate department, or any other criteria desired by the corporate IT personnel.

Upon logging on to the RMC, the corporate IT personnel may set times when any PC or group of PCs must be available for access, and hence must not be in a Low Power Standby state. This is the Schedule Data, defining maintenance windows. These will generally be defined by Wake Up Times, being times at which the PC must be moved into an Active Use state if not already in that state, and a time period from that time, during which the PC must not be moved into a Low Power Standby state. These maintenance windows may be set for PCs by group. For example, all PCs in a department or a building may form one group. Membership of multiple groups is permitted. The RMC will calculate the result of a given PC being in multiple with different maintenance windows such that the maintenance window for that PC covers the requirements of all groups. This means that very large maintenance windows need not be specified for all PCs merely to cover the requirements of a small number of machines.

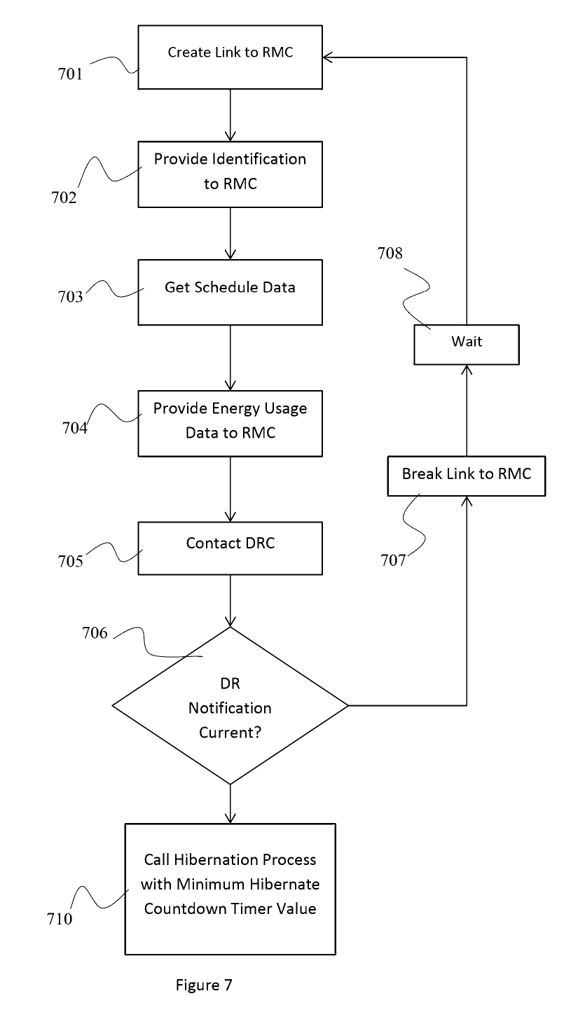

When the PC is in an Active Use state the SCM communicates with the RMC via the Cloud Communication Process of FIG. 7.

The Cloud Communication Process allows the SCM to communicate with the RMC. There are three main functions of the Cloud Communication Process. The first is to allow the SCM to access the Schedule Data. The second is to allow the SCM to provide power usage data, supplied to the SCM by the ESD, to the RMC. The third is to permit the PC installation to engage in DR events.

The first step in the Cloud Communication Process is Create Link to RMC 701. The process uses the PC's internet connection to create a link to the RMC. The internet address which the process attempts to connect to is pre-set at the time of installation of the SCM. It is preferred that the SCM initiate contact rather than the RMC to avoid the need to negotiate firewalls and NAT devices which could make the SCM difficult or impossible to locate from the public internet.

In the preferred embodiment, communication is via the public internet, but any other network available to both the SCM and the RMC may be used.

As part of the link creation or separately the SCM identifies itself 702 to the RMC. This may be via an externally provided digital certificate, a unique identifier, or any other suitable identification process. It is preferred that no user action is required at any point in the identification process.

The identification is matched by the RMC to a database of SCM PC installations. This database includes such information as the electricity supply network to which the PC installation is connected, and any overall restriction on the participation of the installation in demand response events. The database may also include sufficient information about the installation to allow an estimate of the energy savings available from the participation of the installation in a demand response event.

In a preferred embodiment, information about the PC installation, held by the RMC database, will have been collected by the installer of the SCM and supplied to the RMC at the time of installation. In an alternative embodiment, these details are communicated to the RMC by the SCM.

The RMC may service more than one Utility. In a preferred embodiment, each PC installation is associated with one Utility. Demand response event notifications will only be passed to the SCM of a PC installation when the event has been requested by the associated Utility.

In an alternative embodiment, a PC installation may be associated with more than one utility. The PC installation may be informed of demand response events for each associated Utility. The identity of the Utility requesting the demand response notification may be passed to the SCM along with the notification.

The Cloud Communication Process continues with the SCM obtaining 703 the Schedule Data for the PC from the RMC.

The SCM now provides 704 the energy usage data concerning the PC installation to the RMC. The usage data may be the raw data provided to the SCM by the ESD, it may be the results of analysis of that raw data, or it may be any combination or subset of the two types of data.

The RMC receives power usage data from many SCMs. This data is combined with the information concerning the Utility supplying power to the PC connected to each ESD, and the physical location of the PC, to determine characteristics of the power consumption of the PC both instantaneously and as a function of time. The RMC uses this data to model power usage over the PCs with which it is in communication. This may include predictions of future power use, reporting of current power use, and predictions of the magnitude of power reduction which could be achieved at a given time and place should such a reduction be desired by a Utility.

The RMC includes a Demand Response Controller (DRC) 103. The DRC may receive from the Utility a demand response event notification, being an indication that a reduction in load on the electricity supply network is desirable. The DRC is then able to issue a demand response event request to the personal computer installations 100.

The demand response event request is intended to elicit a response from at least some of the personal computer installations whereby the installations move to a lower energy use state, thus relieving the load on the electricity supply network.

The RMC may service more than one Utility. In a preferred embodiment, each PC installation is associated with one Utility. Demand response event notifications will only be passed to the SCM of a PC installation when the event has been requested by the associated Utility.

In an alternative embodiment, a PC installation may be associated with more than one utility. The PC installation may be informed of demand response events for each associated Utility. The identity of the Utility requesting the demand response notification may be passed to the SCM along with the notification.

The Cloud Communication Process makes contact 705 with the DRC. The Process then checks 706 with the DRC to ascertain if a demand response event notification relevant to the PC installation is current. If there is no current event, the process waits 708 for a period of time before again sending usage data to the RMC. In an embodiment where the link to the RMC is broken and remade for each communication, it is at this point that the link is broken 707 before, and remade after 701, the Wait step.

Where it is determined that there is a relevant demand response event in progress, the process calls 710 the Hibernate Process. This call to the Hibernate Process specifies that the Hibernate Countdown Timer should be set to a minimum value. In a preferred embodiment, this value is 30 seconds.

The Hibernate Process then runs normally. The reduced Countdown Timer value ensures that the PC is moved into Low Power Standby almost immediately where there is no user engagement with the PC. Where there is user engagement, the user will indicate that the PC should not be shut down by reacting to the displayed shut down warning, thus preventing the shutdown.

In a preferred embodiment, the shutdown warning displayed when the impending shutdown is in response to a demand response event notification includes the information that the impending shutdown is in response to a demand response event notification. In an embodiment where the identity of the Utility is passed to the SCM by the DRC, this identity may also be displayed. Where the shutdown is in response to a demand response event notification, a user may wish to participate by allowing the PC to be put into a standby mode even though this would otherwise be inconvenient. Therefore, in this embodiment, the Hibernation Process is called whenever a demand response notification is received, regardless of the activity level of the PC. The shutdown warning includes a facility allowing the user to explicitly accept or reject the option of allowing the PC to be placed in standby to participate in the DR event.

In a preferred embodiment, immediately prior to the Force Hibernate step 411 of the Hibernate Process, the fact that the PC is about to be shutdown will be communicated to the DRC. This may occur in all cases, or only when the shutdown occurs in response to a demand response event notification.

In any embodiment, the RMC may receive information about the estimated power consumption of each PC installation. This may be received directly from the SCM reporting measured energy consumption as measured by the energy saving device, or it may be information from a database indicating what devices were found to be part of the PC installation at the time the SCM was installed.

The connection of each SCM indicates that the respective PC installation is not in a Low Power Standby mode. Where an SCM has not linked to the RMC for a period longer than the delay period of step 708 of FIG. 7, the RMC may infer that the PC installation is in a low power state. In any case, the particular installation will not be able to be instructed to join a demand response event. The RMC may also receive notification directly from the SCM that the PC will immediately be put into a Low Power Standby state.

The RMC uses this information to estimate the possible energy savings which could be achieved in response to a demand response event notification. This estimate is made available to the Utility, to be used in deciding to request a demand response notification.

When the PC returns to use from a shutdown condition, the SCM will make contact with the RMC. The RMC can then determine that the PC is not in a Low Power standby state. The information about which PC installations were shutdown, with the information concerning when the installation returned to use, is communicated to the DRC which enables the DRC to calculate what magnitude of energy was saved over what period. This is reported to the RMC and hence to the Utility. The Utility may pay the RMC for this energy saving.

The DRC may have information concerning the geographical location of the customers having the SCM installed. This may be used to allow the Utility to restrict the demand response event notification to a particular are where, for example, the need to reduce demand is related to a distribution problem affecting only a limited area.

The DRC may be in communication with SCMs from PC installations provided with electricity by from a variety of supply networks and customers of a variety of Utilities. Each Utility will be provided information only about installations which are connected to its network or belonging to its customers.

Installation of the SCM and the corresponding energy saving device may be financed by the owner of the RMC or by the Utility. The co-operation of the consumer who owns the PC installation may be obtained by providing the energy saving device free of charge or at a reduced price. Other financial inducements or non-financial inducements may be provided to the customer to allow the installation of the SCM, and to participate in demand response events.

In an embodiment, the SCM may include a user interface allowing a customer to indicate that they wish to be notified of any demand response event, and given the opportunity to participate. In this embodiment, the SCM will display the shutdown warning whenever a demand response event notification is received, regardless of the power mode of the computer. Thus customer will then be given the opportunity to respond by either giving or refusing permission for shutdown to take place. There may also be given an indication of the duration of the event, allowing the customer to avoid bringing the PC out of shutdown for that period of time. Where this is combined with the ability of the DRC to record when the PC installation returned to use, the DRC can verify that an installation participated fully in the demand response event. The RMC owner or the Utility may provide some form of payment or reward for this participation.

The SCM now has the Schedule Data. The SCM will not command the PC to go into a low power mode during these windows. The operating system of the PC is instructed by the SCM to schedule a wake up event at the times specified in the Schedule Data. This ensures that if the PC is in a Low Power Standby state at a wake up time, the PC will move into an Active Use state.

The SCM continues to operate normally. This means the PC will, in the absence of user input, enter a Low Power Standby state. In this state the SCM is not operational. Wake up times which have been communicated to the SCM will be honoured, because the Schedule Data has been incorporated into the scheduling process of the operating system of the PC. However, the time at which the next contact with the RMC will occur is not determined, since if no wake up event occurs, and the PC remains unused, the SCM will not run, and there will be no contact with the RCM.

This situation is not acceptable to many corporate IT departments who need to be prepared for deployment of emergency patches or unexpected software updates to deal with such things as zero day events. Corporate IT departments may impose a maintenance window at unnecessarily frequent intervals in order to be confident of having access to PCs to deal with such emergent circumstances.

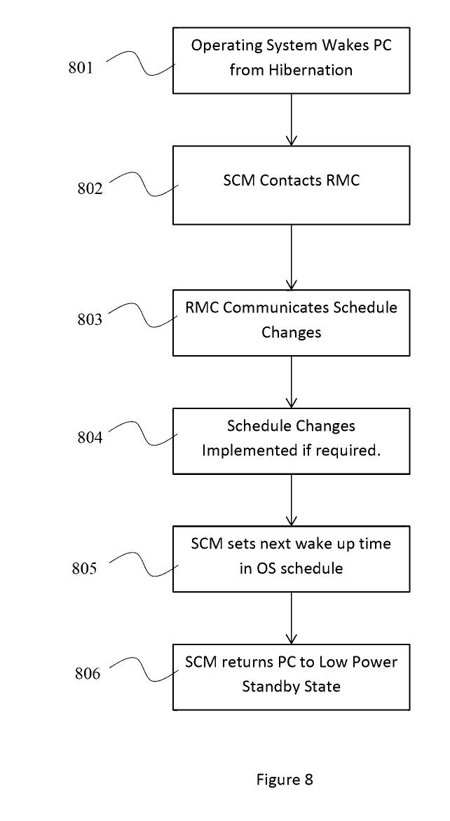

In order to deal with this the SCM instructs the PC to wake periodically as described in FIG. 8.

The PC is in a Low Power Standby state. In response to a previous event scheduled by the SCM, the operating system of the PC wakes 801 the PC, and the SCM runs a restricted subset of functionality.

The SCM makes contact 802 with the RMC. There is no need to run the full process of FIG. 7. There is no new usage data to report, since the SCM has not been active, and has not received any data from the ESD since the PC was put into a Low Power Standby state. There is no need to enquire about DR events, since the PC will be put back into the Low Power Standby state in any case.

The SCM queries 803 the RMC for any changed schedule data. This amended Schedule Data might include instructions to keep the PC in Active Use state to receive an update for a zero day event.

The new Schedule Data, if any, is acted upon 804.

If the Schedule Data does not require the PC to remain active, the SCM sets a scheduled wake up in the operating system for a time which is a wait time in the future 805, then returns the PC to a Low Power Standby state 806.

The brief period of Active Use of the PC will be detected by the ESD, which will switch power on to the peripherals. This is a waste of a small amount of energy, and may also be a nuisance to people around but not using the PC installation, if the peripherals make noise, or flash lights when starting up.

In an embodiment, the SCM communicates to the ESD via the Communications Module, instructing the ESD not to turn on the power to the peripherals. In the event that the PC remains in Active Use state, a further command is sent causing the ESD to provide power to the peripherals outlet. This may also be achieved by a time out rather than an explicit command.

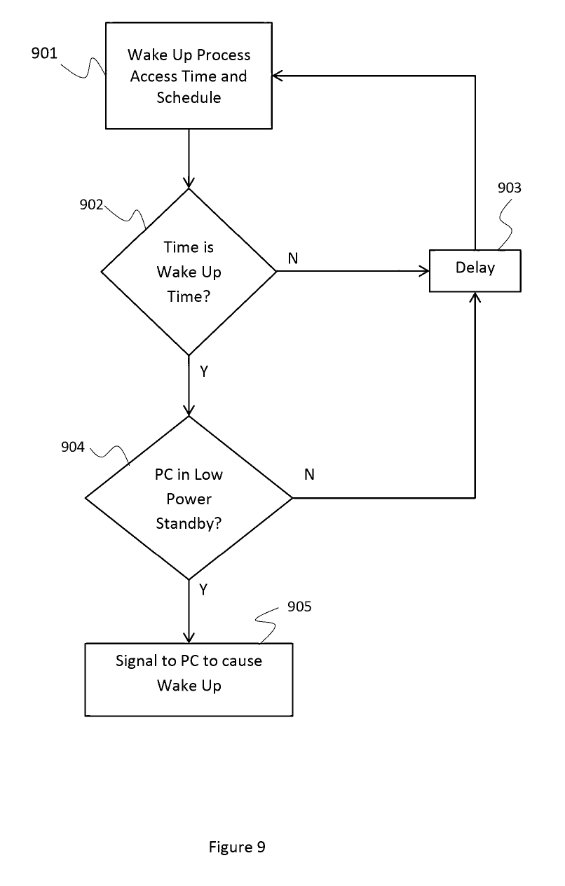

In an embodiment, the Wake Up Schedule may be stored on the ESD. A flowchart of the Wake Up Process which runs continuously on the processor 304 of the energy saving device 201 in such an embodiment is shown in FIG. 9. This requires that the PC be able to be configured such that it can be woken up by an external command which does not require the physical manipulation of a mouse or keyboard.

The energy saving device includes a real time clock. The Wake Up Process accesses 901 the real time and the list of wake up times. The real time and the next wake up time are compared 902 to determine if a wake up is scheduled. If the time is not a wake up time, the there is a delay 903 and the process loops to 901.

When it is determined that a wake up is required the process then checks 904 to see if the PC is in Low Power Standby. If the PC is in Low Power Standby, the energy saving device will have operated the switch 302 to remove power from the peripherals. If the PC is not in Low Power Standby, a wake up in not required. The process loops with a delay 903 back to the start 901.

Where it is determined that the computer requires a wake up, the energy saving device runs Command Wake Up process 905.

The energy saving device may wake the PC in any convenient manner. Where the energy saving device is connected to the PC via a USB link, the energy saving device may simulate mouse and/or keyboard movement. This will be detected by the PC as local user activity and the PC will emerge from Low Power Standby.

Alternatively, the PC and the energy saving device may be connected by a network connection. The energy saving device may issue a Wake-on-LAN packet to the PC, causing the PC to wake up.

A user may wish to participate in DR events, but may not be in a position to allow the computer to be shutdown. Many computers have energy saving features which allow for energy to be saved without shutting down the computer. These include, without limitation, such features as the ability to dim screens and monitors and to reduce CPU speeds. There may also be a capacity to spin down some or all hard drives. Devices with multiple GPUs may have a capacity to switch to a GPU which has lower performance and hence lower energy use. Fan operation may be reduced, either by the reduced energy consumption placing less strain on the cooling system, or by direct command. Operating temperatures may be permitted to rise temporarily to reduce fan use. Ethernet or other high speed communication channel use may use significant energy and there may be a capacity to slow communications rates to save energy.

In an embodiment, the SCM defines a reduced energy use power use state which is defined by implementing at least one energy saving feature such as those listed previously. In a preferred embodiment the reduced energy use power use state is made up of a suite of settings for such features. The SCM may implement a user interface which allows a user to define the characteristics of the reduced energy use power use state. This user interface allows the user to predetermine whether the reduced energy power use state is available in response to a DR event.

The participation of the PC in the DR event, whether the PC participated in the DR event for the full duration of the event, withdrew from the event, or changed parameters during the event, is reported to the RMC. This enables the RMC to calculate the energy savings contributed to the DR event by the PC. The RMC or the Utility may provide some form of payment or reward based on the level of participation and the energy saved by that participation.

In other embodiments, the data link 208 between the SCM and the energy saving device may be absent or the energy saving device may be completely absent.

In other embodiments, the SCM may directly instruct the processor or the switch to remove power from the switched electrical outlet, before the PC is placed into a Low Power Standby mode.

In a further embodiment, the energy saving device may be adapted to remove power from both the peripherals outlet and the monitored outlet when the Low Power Standby mode is detected. This allows the standby energy consumption of the PC itself to be saved also. In this case, an interrupt is provided to allow a user to indicate to the energy saving device that they wish to use the PC and that power should be returned to the monitored outlet. The interrupt may be a user operated device such as a push button, or it may be a device for detecting user presence, such as a movement detector.

The energy saving device may take any desired form but preferably is a power board, a general power outlet (GPO), a wall plug or an energy centre. It is preferred that the system or method of the invention are used in connection with “plug-in” electrical devices, but the system or method may also be used with electrical devices which are permanently wired to mains electrical power. In the latter case, the energy saving device could be incorporated into the mains wiring infrastructure or incorporated as an integral part of mains powered equipment.

Although the invention has been herein shown and described in what is conceived to be the most practical and preferred embodiments, it is recognised that departures can be made within the scope of the invention, which is not to be limited to the details described herein but is to be accorded the full scope of the disclosure so as to embrace any and all equivalent devices and apparatus.

1.-18. (canceled)

19. An energy saving device including:
a. an electrical inlet configured to connect to a general power outlet,
b. a monitored electrical outlet configured to connect to a computing device,
c. a switched electrical outlet configured to connect to, and to supply electrical power to, a peripheral device,
d. a switch configured to control electrical connection of the electrical inlet to the switched electrical outlet, and thereby control supply of electric power to any peripheral device connected to the switched electrical outlet,
e. a first sensor configured to:
(1) sense a characteristic of an electrical power flow through the monitored electrical outlet to any computing device connected to the monitored electrical outlet, and
(2) output the sensed characteristic as a first output.

20. The energy saving device of claim 19, wherein the energy saving device is configured to:
a. determine from the first output when any computing device connected to the monitored electrical outlet is in a low power standby mode;
b. receive a schedule including a time at which any computing device connected to the monitored electrical outlet is required to not be in a low power standby mode;
c. determine whether any computing device connected to the monitored electrical outlet is in a low power standby mode at a time when the schedule indicates that any computing device connected to the monitored electrical outlet is required to not be in a low power standby mode; and
d. upon the determination, provide a signal to any computing device connected to the monitored electrical outlet which will cause the computing device to emerge from the low power standby mode.

21. The energy saving device of claim 15:
a. further including a second sensor configured to
(1) sense a characteristic of an electrical power flow through the switched electrical outlet to any peripheral device connected to the switched electrical outlet, and
(2) output the result as a second output;
b. wherein the energy saving device is configured to communicate the first output and the second output to any computing device connected to the monitored electrical outlet.

22. The energy saving device of claim 19:
a. further including a communication module configured to communicate the first output to any computing device connected to the monitored electrical outlet, and
b. wherein the energy saving device is further configured to:
(1) receive an instruction from any computing device connected to the monitored electrical outlet that the switch should be operated, and
(2) operate the switch in response to the instruction.

23. A method for improving energy efficiency in an electricity supply network, the method including the steps of:
a. creating a data link from a computing device to an external remote management center;
b. receiving from the remote management center a schedule including a time period when the computing device is required not to be in a low power standby state;
c. instructing the operating system of the computing device to be in a use state other than a low power standby state during the time period.

24. The method of claim 23 further including the steps of:
a. monitoring an activity level of the computing device;
b. determining an activity mode of the computing device from the activity level;
c. upon determining that:
(1) the activity mode has been other than an active use mode for a time period exceeding a threshold time period, and
(2) the current time is not within a time period which the schedule defines as a time period when the computing device is required not to be in a low power standby state,
activating a user interface allowing a user to provide a user indication indicating that the computing device should not be placed in a low energy use power state.

25. The method of claim 24 further including the step of commanding the computing device to enter a low energy power use state if no user indication is provided.

26. A computer implemented system for improving energy efficiency in an electricity supply network, the system being configured to:
a. create a data link to an external remote management center;
b. receive from the remote management center a schedule including a time period when a computing device is required not to be in a low power standby state;
c. instruct the operating system of the computing device to be in a use state other than a low power standby state during the time period.

27. The computer implemented system of claim 26, the system further being configured to:
a. monitor an activity level of the computing device;
b. determine an activity mode of the computing device from the activity level;
c. upon determining that:
(1) the activity mode has been other than an active use mode for a time period exceeding a threshold time period, and
(2) the current time is not within a time period which the schedule defines as a time period when the computing device is required not to be in a low power standby state,
activate a user interface allowing a user to provide a user indication indicating that the computing device should not be placed in a low energy use power state.

28. The computer implemented system of claim 27, the system further being configured to command the computing device to enter a low energy power use state if no user indication is provided.

29. The computer implemented system of claim 26 wherein:
a. the remote management center includes a demand response controller;
b. the system is further configured to receive from the demand response controller a demand response event request, wherein upon receipt of the demand response event request command, the operating system of the computing device is instructed to enter a low energy power use state.

30. The computer implemented system of claim 26 further including:
a. an energy saving device having at least one monitored electrical outlet configured to supply electrical power to the computing device;
b. a first sensor configured to:
(1) measure the electrical power supplied to the computing device via the monitored electrical outlet, and
(2) output the result of the measurement; and
c. a communication module configured to communicate the output of the first sensor to the computer implemented system.

31. The computer implemented system of claim 30 wherein the system is further configured to communicate the output of the first sensor to the remote management center.

32. The computer implemented system of claim 30 wherein:
a. the energy saving device further includes:
(1) at least one second electrical outlet configured to supply electrical power to a peripheral of the computing device,
(2) a second sensor configured to:
(a) measure the electrical power supplied to peripheral via the second electrical outlet, and
(b) output the result of the measurement as a second output;
b. the communication module is further configured to communicate the output of the second sensor to the computer implemented system.

33. The computer implemented system of claim 32 wherein the system is further configured to communicate the output of the first sensor and the output of the second sensor to the remote management center.

34. The computer implemented system of claim 30 wherein the communication module is defined by one or more of:
a. a USB connection, and
b. a wireless connection.

35. A computer implemented remote management center for improving energy efficiency in an electricity supply network, the center being configured to:
a. receive from each of several users a schedule of times when each user's computing device is required to not be in a low power user state;
b. establish communications with each of the computing devices, and
c. communicate to each computing device the schedule of times when that computing device is required to not be in a low power standby state.

36. The computer implemented remote management center of claim 35 further configured to:
a. receive from each of several computing devices data describing the power usage of each computing device;
b. receive from each of several installers installation data describing the place and electrical supply of the installation of the computing devices; and
c. predict power usage of the computing devices from the installation data.

37. The computer implemented remote management center of claim 36 further configured to predict energy savings achievable from application of a demand response event request to the computing devices.

38. The computer implemented remote management center of claim 35:
a. further including a demand response controller configured to
(1) receive from a utility a demand response event request, and
(2) select which of the computing devices should be requested to join the demand response event in dependence on:
(a) the demand response event request, and
(b) information received from each computer,
b. wherein the remote management center communicates the demand response event request to each of the selected computing devices upon establishing communications with each of the selected computing devices.
